(19) United States
(12) Patent Application Publication
(10) Pub. No.: US 2012/0253583 A1
(43) Pub. Date: Oct. 4, 2012

(54) IMAGING-BASED PROXIMITY DETECTION SYSTEMS FOR MINING MACHINES

(76) Inventor: David Kevin Herdle, Franklin, PA (US)

(21) Appl. No.: 13/078,650

(22) Filed: Apr. 1, 2011

(51) Int. Cl. G05B 9/00; G05D 1/02; G06F 19/00

(52) U.S. Cl. 701/28

(57) ABSTRACT

Systems, methods, and computer-readable medium for controlling a mining machine. One system includes an image sensor for capturing an image of an area adjacent to the mining machine and a proximity sensing and control system. The proximity sensing and control system obtains the image; identifies an object in the image, the object including at least one of a person and piece of equipment; calculates a distance between the identified object and at least one of the image sensor and the mining machine using at least one image processing algorithm; and automatically controls the mining machine based on the distance.

### FIELD OF THE INVENTION

Embodiments of the invention relate to methods and systems for detecting objects located around a mining machine.

### SUMMARY OF THE INVENTION

Coal and other minerals are typically mined from underground deposits. Given the conditions present in mines and the large equipment used in underground mining, people and other equipment are sometimes tracked to avoid injuries or damages. Some mines and mining machines use radio communications to track people in a mine, which requires that all people in the mine wear electronic transceivers.

One embodiment of the invention provides a system for controlling a mining machine. The system includes an image sensor for capturing an image of an area adjacent to the mining machine and a proximity sensing and control system. The proximity sensing and control system obtains the image; identifies an object in the image, the object including at least one of a person and piece of equipment; calculates a distance between the identified object and at least one of the image sensor and the mining machine using at least one image processing algorithm; and automatically controls the mining machine based on the distance.

Another embodiment of the invention provides a computer-implemented method for controlling a mining machine. The method includes obtaining an image of an area adjacent to the mining machine; identifying an object in the image, the object including at least one of a person and piece of equipment; calculating a distance between the identified object and at least one of the image sensor and the mining machine using at least one image processing algorithm; and automatically controlling the mining machine based on the distance.

Still another embodiment of the invention provides non-transitory computer-readable medium encoded with a plurality of processor-executable instructions for controlling a mining machine. The instructions including obtaining an image of an area adjacent to the mining machine; identifying an object in the image, the object including at least one of a person and piece of equipment; calculating a distance between the identified object and at least one of the image sensor and the mining machine using at least one image processing algorithm; and automatically controlling the mining machine based on the distance.

Other aspects of the invention will become apparent by consideration of the detailed description and accompanying drawings.

### BRIEF DESCRIPTION OF THE DRAWINGS

FIG. 1 is a perspective view of a shuttle car for a mining machine according to one embodiment of the invention.

FIGS. 2-3 schematically illustrate the shuttle car of FIG. 1.

FIG. 4 is a perspective view of a continuous miner according to one embodiment of the invention.

FIGS. 5-6 schematically illustrate the continuous miner of FIG. 4.

FIG. 7 is a front view of a hard rock continuous miner according to one embodiment of the invention.

FIG. 8 schematically illustrates an interface sensing and control system for the mining machines of FIGS. 1-7.

FIG. 9 is a flow chart illustrating a method performed by the interface sensing and control system of FIG. 8 to identify a seam in a cutting face.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium). As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

As previously described, mining machines operate in confined spaces. Often people have to come within close proximity of a mining machine in operation, and sometimes people get too close to a mining machine without realizing it, or a mining machine approaches too fast for someone to get out of the way. In these situations, the person may get injured if they are struck by the mining machine. Similarly, a mining machine can get too close to other equipment located in the mine. If a mining machine strikes other equipment, both the mining machine and the other equipment can be damaged. Damaged mining machines and equipment can lead to unsafe operating conditions. For example, if a roof support is struck by a mining machine, the stability of the mine may be compromised. In some mines, a radio communication system is used to detect and track the location of people in the mine. In these systems, all people present in a mine are required to wear electronic receivers. If a worker forgets to wear their receiver or the receiver malfunctions, the worker's location may not be tracked or may be improperly tracked, which creates unsafe conditions for the worker. Also, providing and maintaining an electronic receiver for each worker can post significant costs.

Accordingly, as described in more detail below, embodiments of the present invention use a proximity sensing and control system that includes one or more image sensors, such as cameras, thermal cameras or sensors, laser measurement devices, etc., to take images around a mining machine. The proximity and detection system detects people, pieces of equipment, and other objects within the field of view of the image sensors. In some embodiments, multiple image sensors may be positioned in multiple locations around a mining machine to increase the field of view around the machine. The data gathered from the image sensors is processed by the proximity sensing and control system to identify an object in the image and calculate the distance an identified object is from the mining machine. This information can be used by a mining machine control system to automatically control movement of the mining machine (e.g., stop movement of the mining machine when the object is too close). Alternatively or in addition, the information can be provided to an operator, which allows the operator to manually modify operation of the mining machine as desired or direct people or equipment to be moved out of range of the mining machine.

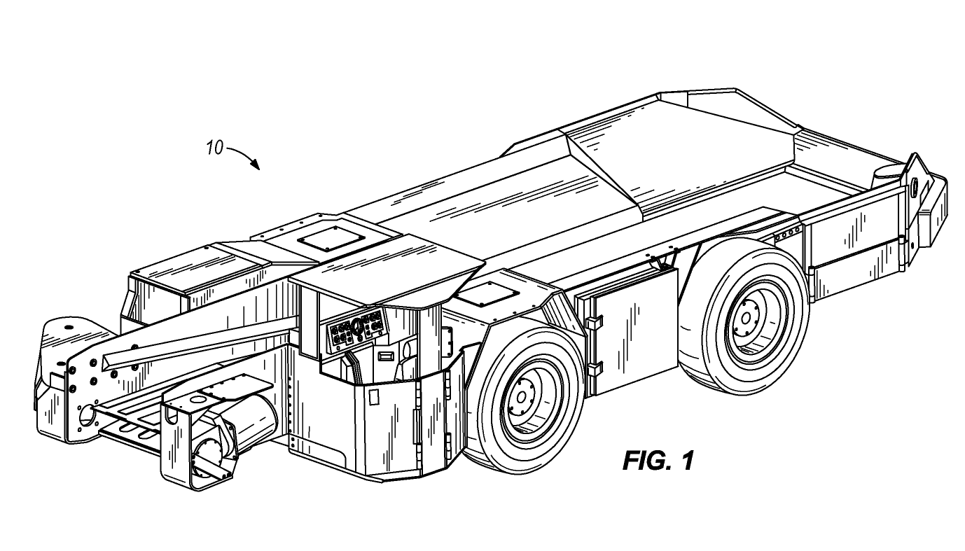

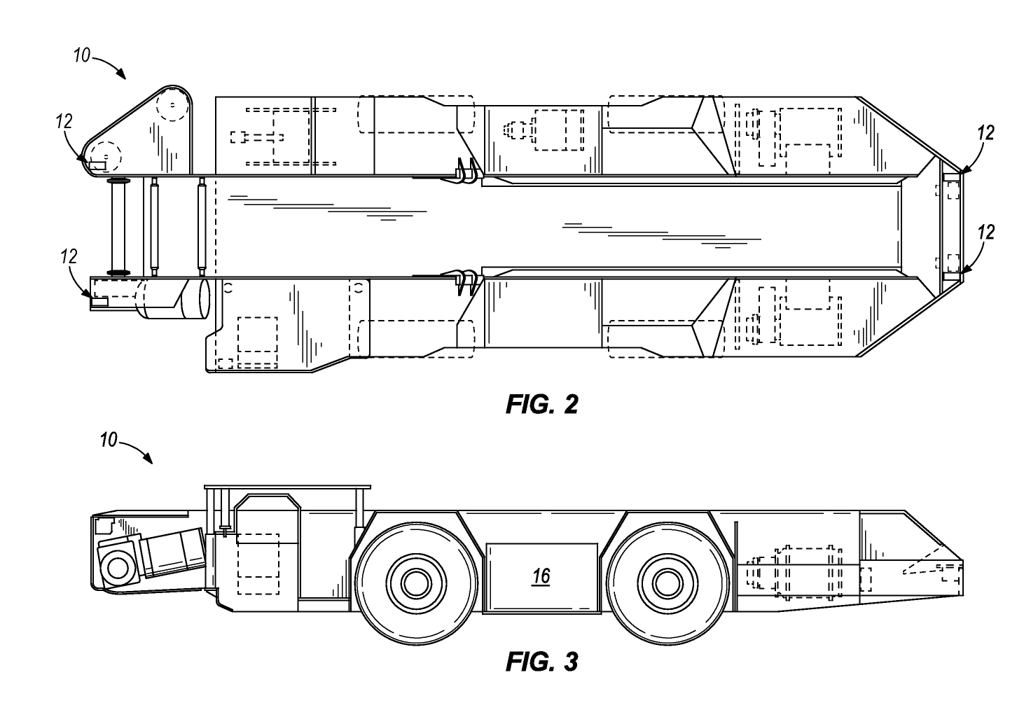

FIGS. 1-3 illustrate a shuttle car 10 according to one embodiment of the invention. The shuttle car 10 moves cut material away from the working face of a mine. As shown in FIG. 2, the shuttle car 10 can include an image sensor 14 at one or more corners of the car 10. The shuttle car 10 can also be controlled by a mining machine control system 16.

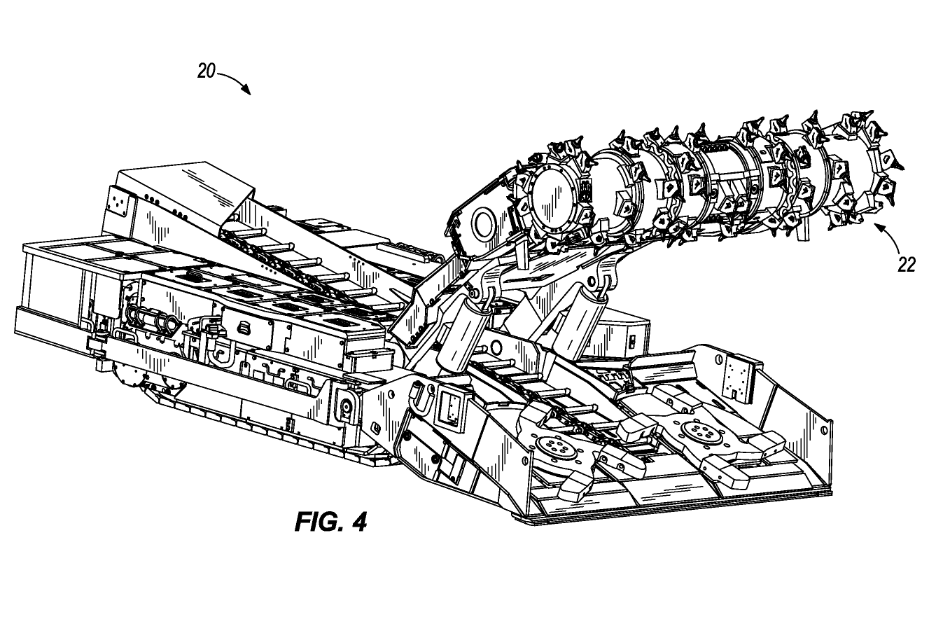

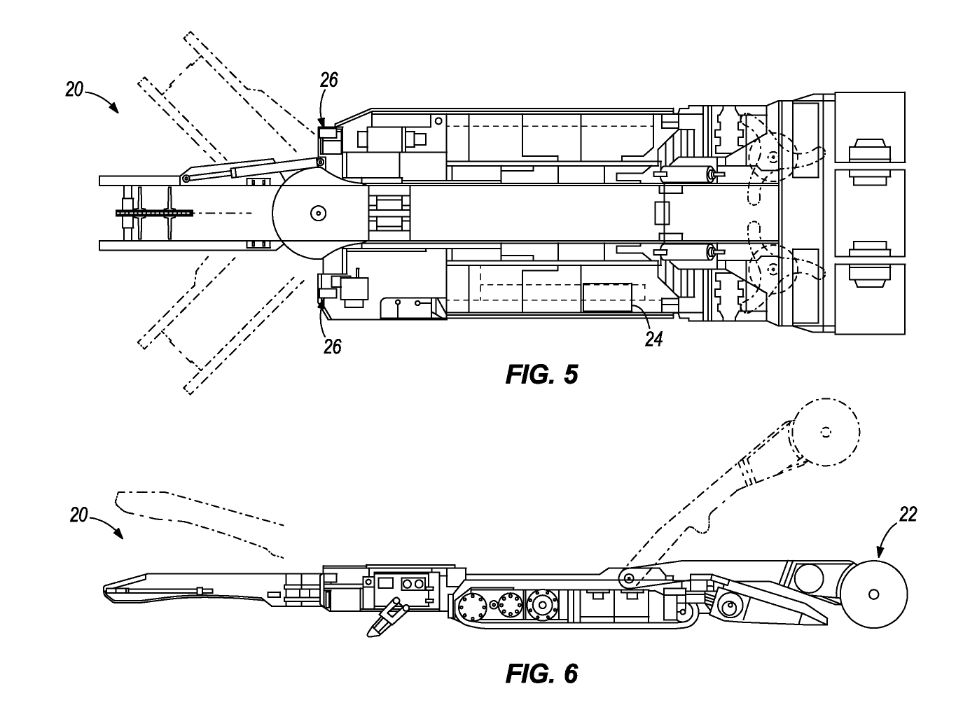

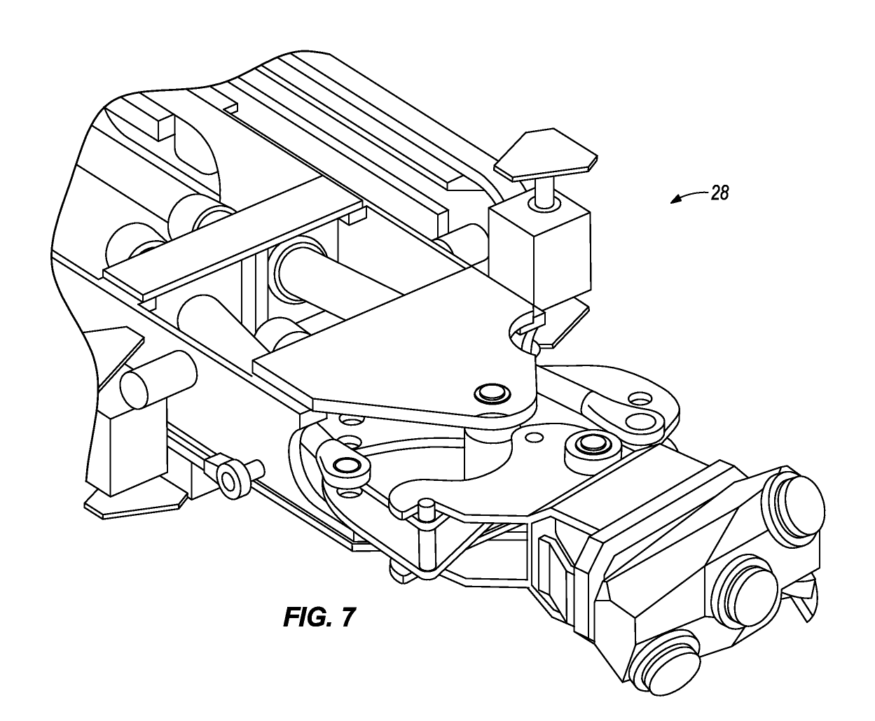

In some embodiments, the shuttle car 10 is positioned adjacent to a mining machine, such as a continuous miner 20, as illustrated in FIGS. 4-6. The continuous miner 20 can include a cutterhead 22 that can be controlled by a mining machine control system 24. Alternatively or in addition to the image sensors 14 on the shuttle car 10, the continuous miner 20 can include one or more image sensors 26. For example, as shown in FIG. 5, the continuous miner 20 can include an image sensor 26 at one or both of the rear corners. It should be understood that the miners illustrated in FIGS. 1-6 are merely examples of miners and that the methods and systems disclosed herein can be used with various types of miners in various configurations. For example, FIG. 7 illustrates a hard rock continuous miner (“HRCM”) 28 that can include image sensors similar to the sensors 24 included in the continuous miner 20.

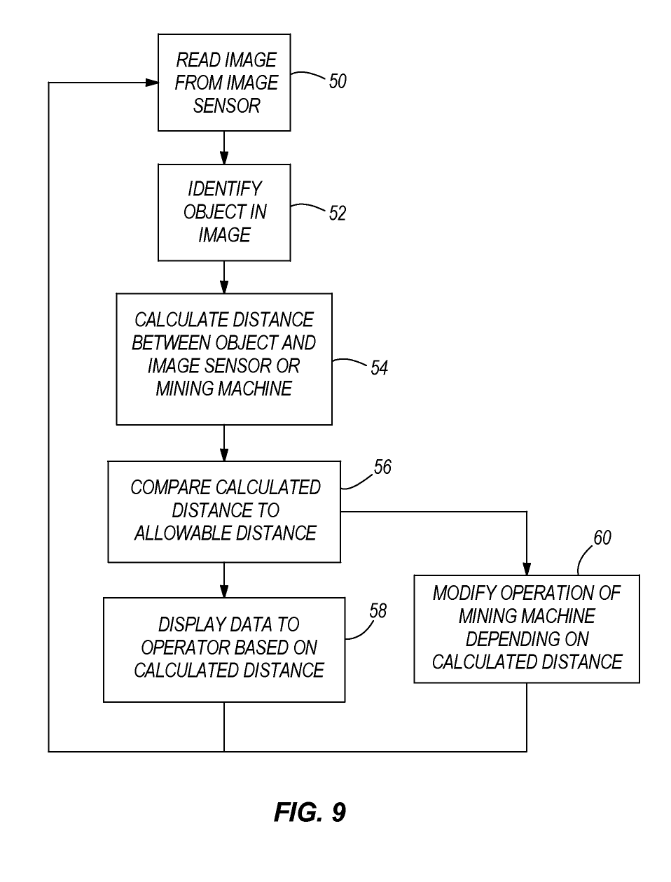

The image sensors 14 and 26 can include a camera (still or video), a thermal camera or sensor, a laser measurement device, or other imaging devices. The image sensors 14 and 26 are connected to a proximity sensing and control system. The interface sensing and control system can be included in the mining machine. However, in some embodiments, the interface sensing and control system can be included in a device separate from the mining machine, such as other mining machinery (e.g., a shuttle car) or a control panel used by an operator to control the mining machine. Furthermore, in some embodiments, the functionality performed by the interface sensing and control system can be distributed between multiple devices. The proximity sensing and control system can have built-in frame grabbers or the frame grabbers may be built into the image sensors 14 and 26. The image sensors 14 and 26 can be interfaced to the proximity sensing and control system via a communication interface, such as a high speed firewire. As described below with respect to FIG. 9, images from the image sensor 14 and 26 are obtained by the proximity sensing and control system and processed.

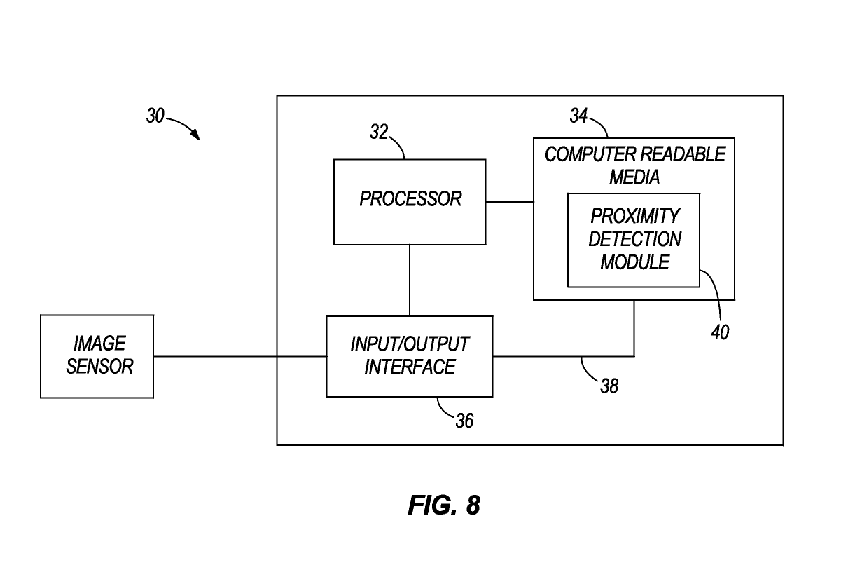

FIG. 8 schematically illustrates a proximity sensing and control system 30 according to one embodiment of the invention. It should be understood that FIG. 8 illustrates only one example of components of a proximity sensing and system 30 and that other configurations are possible. As shown in FIG. 8, the system 30 includes a processor 32, computer-readable media 34, and an input/output interface 36. The processor 32, computer-readable media 34, and input/output interface 36 are connected by one or more connections 38, such as a system bus. It should be understood that although only one processor 32, computer-readable media module 34, and input/output interface 36 are illustrated in FIG. 8, the system 30 can include multiple processors 32, computer-readable media modules 34, and input/output interfaces 36. Also, the functionality provided by the proximity sensing and control system 30 can be distributed among multiple controllers or systems or can be combined with other controllers or systems. For example, in some embodiments, the proximity sensing and control system 30 can be combined with the mining machine control systems 16 and 24. Some of the functionality performed by the proximity sensing and system 30 can also be performed by the image sensors 14 and 26.

The processor 32 retrieves and executes instructions stored in the computer-readable media 34. The processor 32 can also store data to the computer-readable media 34. The computer-readable media 34 can include non-transitory computer readable medium and can include volatile memory, non-volatile memory, or a combination thereof. In some embodiments, the computer-readable media 34 includes a disk drive or other types of large capacity storage mechanism.

The input/output interface 36 receives information from outside the system 30 and outputs information outside the system 30. For example, as shown in FIG. 8, the input/output interface 36 can receive images from an image sensor, such as the image sensors 14 and 26 described above. The input/output interface 36 can also transmit signals, data, instructions, and queries to mechanical and electrical equipment located outside the system 30 that operate and control the cutterhead or other components of the mining machine, such as the mining machine control systems 16 and 24.

The instructions stored in the computer-readable media 34 can include various components or modules configured to perform particular functionality when executed by the processor 32. For example, the computer-readable media 34 can include a proximity detection module 40, as shown in FIG. 8. The proximity detection module 40 can be executed by the processor 32 to detect people, equipment, or other objects positioned around a mining machine. This information can then be provided to the operator or used to automatically control the mining machine to maintain safe conditions within a mine.

FIG. 9 is a flow chart illustrating a method performed by the system 30 when the proximity detection module 40 is executed by the processor 32 according to one embodiment of the invention. As shown in FIG. 9, during operating of a mining machine, images are read from the image sensors 14 and 26 (at 50). The images are then digitized and analyzed to identify any objects in the images, such as people or equipment (at 52). The objects can be identified in the images using shape detection and/or heat detection. For example, one or more of the image sensors 14 and 26 may be infra-red sensors, and so heat data can be obtained in the image. The heat data can be used to identify objects that have a temperature above a predetermined threshold temperature, which indicates the object is a person or a piece of equipment that is currently running and generating heat. In addition or alternatively, the proximity sensing and control system can identify shapes in the images and can compare the identified shapes to known shapes, such as known shapes of people or particular mining equipment.

Once an object is identified, the distance between the object and the mining machine is calculated (at 54). It should be understood that the distance can be calculated between an identified object and the image sensor 14 or 26 closest to the identified object or mining machinery, such as a mining machine or related equipment (e.g., a shuttle car). In some embodiments, if the image sensors as mounted on the mining machinery, the distance between the identified object and the mining machine is approximately equal to the distance between the identified object and the image sensor. Alternatively, if the image sensor is not located on the mining machine, but rather is positioned on related equipment, such as a shuttle car, a distance can be calculated between the identified object and the image sensor and this distance can be used as the distance to the mining machine or can be modified to account for the position of the image sensor separate from the mining machine.

Calculating this distance can be performed in various ways using one or more image processing algorithms. In one method, this distance can be calculated using an image sensor and a light source. For example, U.S. Pat. No. 6,296,317, the entire contents of which are hereby incorporated by reference, describes methods for calculating such a distance using various light sources. For example, one method disclosed in U.S. Pat. No. 6,296,317 uses a camera that has a filter that picks up only light having the wavelength of a diffused light source and a light strip source. The camera captures an image of a portion of a mine and a computer digitizes the image and separates the image into first and second, or even and odd, data fields. The even data fields show the image illuminated by the diffused light source, and the odd data fields show the image illuminated by the striping light source. The odd data field can then be used to determine the distance between the camera and the portion of the mine captured in the image. Other image processing algorithms for calculating a distance based on image data are also disclosed in U.S. Pat. No. 6,296,317.

Another method for determining the distance between an identified object and a mining machine can use the known shape and size of particular objects, such as a human head with a helmet and a cap lamp. Once this particular shape is identified in an image, the distance can be calculated using one or more image processing algorithms. For example, in some embodiments, the distance can be calculated by counting the number of pixels representing the identified shaped in the captured field of view and comparing the number of pixels with a known pixel number for the shape located a known distance from the image sensor. It should be understood that a uniquely shaped reflective sticker or marker can be placed on people or equipment located in a mine and the known shape and size of the sticker or marker can be used to calculate the distance between the object and the mining machine.

After the distance between the object and the mining machine is calculated (at 54), the calculated distance can be compared to an allowable distance threshold (at 56). Regardless of whether the calculated distance is less than the allowable distance threshold, the calculated distance and any other information obtained about the identified object(s) (e.g., images of the objects) can be provided to an operator (at 58) (e.g., on an interface or monitor on the mining machine or as part of a report generated and provided to the operator). In some embodiments, such as when an operator is operating a remote-controlled mining machine, the proximity sensing and control system 30 can transmit this information (e.g., over a wired or wireless communication channel, such as an Ethernet connection or a local area network) to an interface located near the operator rather than an interface on the mining machine itself. The operator can use the information provided by the interface sensing and control system to modify operation of the mining machine as desired.

Alternatively or in addition, if the calculated distance is less than the allowable distance threshold, the proximity sensing and control system 30 can automatically control the mining machine to ensure that the identified object is not placed in danger (at 60). In particular, the proximity sensing and control system 30 can output commands to various components of the mining machine (e.g., using the input/output interface 36), such as the mining machine control systems 16 and 24, to automatically halt operation of the mining machine. As described above, in some embodiments, the proximity sensing and control system 30 can be included as part of the mining machine control systems 16 and 24, and, therefore, the same system performs the distance comparison and controls the mining machine. As shown in FIG. 9, the method can be repeated as the mining machine is operating to continually track the location of objects (e.g., people and equipment) located around the mining machine to provide a safe operating environment.

The images and other data obtained by or generated by the proximity sensing and control system 30 can be stored in a memory module, such as the computer-readable media 34 or an external memory module. The stored images and data can be used as a log for operation of a mining machine. Also, the stored images and data can be used to calibrate or train the proximity sensing and control system 30. For example, the stored images can be used to teach the system 30 characteristics, such as shapes and sizes, of various objects that may be positioned around a mining machine, which allows the system 30 to better identify and track objects.

Various features and advantages of the invention are set forth in the following claims.

What is claimed is:

1. A system for controlling a mining machine comprising:
an image sensor for capturing an image of an area adjacent to the mining machine; and
a proximity sensing and control system for obtaining the image, identifying an object in the image, the object including at least one of a person and piece of equipment, calculating a distance between the identified object and at least one of the image sensor and the mining machine using at least one image processing algorithm, and automatically controlling the mining machine based on the distance.

2. The system of claim 1, wherein the image sensor is mounted on the mining machine.

3. The system of claim 1, wherein the image sensor is mounted on a shuttle car positioned adjacent to the mining machine.

4. The system of claim 1, wherein the image sensor includes a still camera.

5. The system of claim 1, wherein the image sensor includes a video camera.

6. The system of claim 1, wherein the image sensor includes a thermal image sensor.

7. The system of claim 1, wherein the image sensor includes a laser measurement device.

8. The system of claim 1, wherein the proximity sensing and control system compares the distance to an allowable distance threshold and automatically stops operation of the mining machine if the distance is less than the allowable distance threshold.

9. The system of claim 1, wherein the proximity sensing and control system identifies an object in the image by comparing heat data included in the image to a predetermined threshold temperature.

10. The system of claim 1, wherein the proximity sensing and control system identifies an object in the image by identifying at least one shape included in the image and comparing the identified shape data to a plurality of known shapes.

11. The system of claim 1, wherein the proximity sensing and control system calculates the distance using at least one image processing algorithm by identifying a shape included in the image, counting a number of pixels representing the identified shape and comparing the number of pixels with a known pixel number for the shape located at a known distance from the image sensor.

12. The system of claim 1, wherein the object includes reflective marker having a known shape and size.

13. The system of claim 1, wherein the proximity sensing and control system calculates the distance by identifying a data field in the image showing the image illuminated by a striping light source and using the data field to calculate the distance between the object and the image sensor.

14. The system of claim 1, wherein the proximity sensing and control system provides data to an operator based on the identified object and the calculated distance.

15. A computer-implemented method for controlling a mining machine, the method comprising:
obtaining an image of an area adjacent to the mining machine;
identifying an object in the image, the object including at least one of a person and piece of equipment;
calculating a distance between the identified object and at least one of the image sensor and the mining machine using at least one image processing algorithm; and
automatically controlling the mining machine based on the distance.

16. The method of claim 15, wherein obtaining the image includes obtaining the image from an image sensor mounted on the mining machine.

17. The method of claim 15, wherein obtaining the image includes obtaining the image from an image sensor mounted on a shuttle car positioned adjacent to the mining machine.

18. The method of claim 15, further comprising comparing the distance to an allowable distance threshold.

19. The method of claim 18, wherein automatically controlling the mining machine includes automatically stopping operation of the mining machine if the distance is less than the allowable distance threshold.

20. The method of claim 15, wherein identifying an object includes comparing heat data included in the image to a predetermined threshold temperature.

21. The method of claim 15, wherein identifying an object includes identifying at least one shape included in the image and comparing the identified shape data to a plurality of known shapes.

21. The method of claim 15, wherein calculating a distance using at least one image processing algorithm includes identifying a shape included in the image, counting a number of pixels representing the identified shape and comparing the number of pixels with a known pixel number for the shape located at a known distance from the image sensor.

22. The method of claim 15, wherein the calculating a distance includes identifying a data field in the image showing the image illuminated by a striping light source and using the data field to calculate the distance between the object and an image sensor capturing the image.

23. The method of claim 15, further comprising providing data to an operator based on the identified object and the calculated distance.

24. Non-transitory computer-readable medium encoded with a plurality of processor-executable instructions for controlling a mining machine, the instructions comprising:
obtaining an image of an area adjacent to the mining machine;
identifying an object in the image, the object including at least one of a person and piece of equipment;
calculating a distance between the identified object and at least one of the image sensor and the mining machine using at least one image processing algorithm; and
automatically controlling the mining machine based on the distance.

25. The computer-readable medium of claim 24, further comprising instructions for comparing the distance to an allowable distance threshold.

26. The computer-readable medium of claim 25, wherein the instructions for automatically controlling the mining machine include instructions for automatically stopping operation of the mining machine if the distance is less than the allowable distance threshold.

27. The computer-readable medium of claim 24, wherein the instructions for identifying an object include instructions for comparing heat data included in the image to a predetermined threshold temperature.

28. The computer-readable medium of claim 24, wherein the instructions for identifying an object include instructions for identifying at least one shape included in the image and comparing the identified shape data to a plurality of known shapes.

29. The computer-readable medium of claim 24, wherein the instructions for calculating a distance using at least one image processing algorithm include instructions for identifying a shape included in the image, counting a number of pixels representing the identified shape and comparing the number of pixels with a known pixel number for the shape located at a known distance from the image sensor.

30. The computer-readable medium of claim 24, wherein the instructions for calculating a distance include instructions for identifying a data field in the image showing the image illuminated by a striping light source and using the data field to calculate the distance between the object and an image sensor capturing the image.

31. The computer-readable medium of claim 24, further comprising instructions for providing data to an operator based on the identified object and the calculated distance.
